(19) United States
(12) Patent Application Publication
(10) Pub. No.: US 2019/0207804 A1
(43) Pub. Date: Jul. 4, 2019

(54) NODE FAULT ISOLATION

(71) Applicant: CA, Inc., Islandia, NY (US)

(72) Inventor: Balram Reddy Kakani, Hyderabad (IN)

(73) Assignee: CA, Inc., Islandia, NY (US)

(21) Appl. No.: 15/859,207

(22) Filed: Dec. 29, 2017

(51) Int. Cl. H04L 12/24; H04L 12/707

(52) U.S. Cl. CPC H04L 41/0659; H04L 45/22; H04L 41/0677; H04L 41/12

(57) ABSTRACT

Aspects of the embodiments are directed to systems, methods, devices, and computer program products for efficient fault isolation in a network of nodes. Embodiments include determining, by a polling network element, a presence of a fault among one or more nodes in a network of nodes; identifying, by the polling network element, a fault domain comprising a list of nonresponsive nodes in the network, the fault domain listing each nonresponsive node and an associated path-based tag for each nonresponsive node; and identifying a root cause of a fault in the network based on a shortest path-based tag in the fault domain.

### FIELD

The present disclosure relates to interactive voice responses.

### BACKGROUND

Computer networks are used to provide increased computing power, sharing of resources, and communication between users. Computer systems and computer system components can be interconnected to form a network. Networks may include a number of computer devices within a room, building or site that are interconnected by a high speed local data link such as local area network (LAN), token ring, Ethernet, or the like. Local networks in different locations may be interconnected by techniques such as packet switching, microwave links and satellite links to form a worldwide network. A network may include several hundred or more interconnected devices.

### SUMMARY

Aspects of the embodiments include a computer-implemented method for fault isolation in a network of nodes, the computer-implemented method including determining, by a polling network element, a presence of a fault among one or more nodes in a network of nodes; identifying, by the polling network element, a fault domain comprising a list of nonresponsive nodes in the network, the fault domain listing each nonresponsive node and an associated path-based tag for each nonresponsive node; and identifying a root cause of a fault in the network based on a shortest path-based tag in the fault domain.

Aspects of the embodiments are directed to a non-transitory computer-readable medium having program instructions stored therein, wherein the program instructions are executable by a computer system to perform operations including determining, by a polling network element, a presence of a fault among one or more nodes in a network of nodes; identifying, by the polling network element, a fault domain comprising a list of nonresponsive nodes in the network, the fault domain listing each nonresponsive node and an associated path-based tag for each nonresponsive node; identifying a root cause of a fault in the network based on a shortest path-based tag in the fault domain.

Aspects of the embodiments are directed to a system that includes a processor; a memory; a poller network element implemented at least partially in hardware, the poller network element to: determine, by the poller network element, a presence of a fault among one or more nodes in a network of nodes; identify, by the poller network element, a fault domain comprising a list of nonresponsive nodes in the network, the fault domain listing each nonresponsive node and an associated path-based tag for each nonresponsive node; identify a root cause of a fault in the network based on a shortest path-based tag in the fault domain.

Aspects of the embodiments are directed to a computer-implemented method for fault isolation in a network of nodes, the method including determining, by a polling network element, a presence of a fault among one or more nodes in a network of nodes; identifying, by the polling network element, a fault domain comprising a list of nonresponsive nodes in the network, the fault domain identifying each nonresponsive node and an associated path-based tag for each nonresponsive node, each path-based tag comprising a prefix and an identifier for a corresponding node; and identifying a root cause of a fault in the network based on a path-based tag prefix.

Aspects of the embodiments are directed to a non-transitory computer-readable medium having program instructions stored therein, wherein the program instructions are executable by a computer system to perform operations including determining, by a polling network element, a presence of a fault among one or more nodes in a network of nodes; identifying, by the polling network element, a fault domain comprising a list of nonresponsive nodes in the network, the fault domain identifying each nonresponsive node and an associated path-based tag for each nonresponsive node, each path-based tag comprising a prefix and an identifier for a corresponding node; and identifying a root cause of a fault in the network based on a path-based tag prefix.

Aspects of the embodiments are directed to a system that includes a processor and a memory, the system including a poller network element implemented at least partially in hardware to determine, by the poller network element, a presence of a fault among one or more nodes in a network of nodes; identify, by the polling network element, a fault domain comprising a list of nonresponsive nodes in the network, the fault domain identifying each nonresponsive node and an associated path-based tag for each nonresponsive node, each path-based tag comprising a prefix and an identifier for a corresponding node; and identify a root cause of a fault in the network based on a path-based tag prefix.

In some embodiments, the poller network element is to manage the one or more nodes of the network of nodes.

Some embodiments can include a fault isolation module to perform fault detection, isolation, and recovery (FDIR), wherein the poller network element is associated with the fault isolation module.

In some embodiments, identifying a fault domain includes determining, by the poller network element, a list of unreachable nodes from the one or more nodes of the network of nodes, wherein the unreachable nodes are coupled for communication with the poller network element.

In some embodiments, the poller network element to determine, by the poller network element, that one or more nodes in the fault domain comprise path-based tags that are longer than the shortest path-based tag; and determine, by the poller network element, that the one or more nodes that comprise path-based tags that are longer than the shortest path-based tag are symptomatic of the fault.

In some embodiments, identifying a root cause of a fault in the network based on a shortest path-based tag in the fault domain includes identifying, from the fault domain, a first path-based tag length; and determining, by comparing the first path-based tag length with one or more other path-based tag lengths in the fault domain, that the first path-based tag length is a shortest path-based tag length.

In some embodiments, the poller network element is to determine a topology of the one or more nodes prior to identifying the fault domain.

In some embodiments, the poller network element is to during a connectivity process, determine a first node linked downstream to the poller network element; assign the first node a first path-based tag, the first path-based tag comprising a first length; determine a second node linked downstream to the first node; assign the second node a second path-based tag, the second path-based tag comprising a second length longer than the first length; determine a third node linked downstream to the second node; and assign the third node a third path-based tag, the third path-based tag comprising a third length longer than the first length and the second length.

In some embodiments, the first path-based tag comprises an identifier of the first node; the second path-based tag comprises the identifier of the first node as a prefix and an identifier of the second node; and the third path-based tag comprises the identifier of the first node and the identifier of the second node as a prefix and an identifier of the third node.

In some embodiments, the poller network element is to communicate by the poller network element to the fault isolation module the root cause of the fault.

Some embodiments can include determining, by the polling network element, that one or more nodes in the fault domain comprise path-based tag prefixes that identify nodes that are present in the fault domain; and determining, by the polling network element, that the one or more nodes that comprise path-based tag prefixes that identify nodes in the fault domain that are symptomatic of the fault.

Some embodiments can include, during a connectivity process, determining a first node linked downstream to the polling network element; assigning the first node a first path-based tag, the first path-based tag comprising an node identifier; determining a second node linked downstream to the first node; assigning the second node a second path-based tag, the second path-based tag comprising a second node identifier and a prefix, the prefix identifying the first node; determining a third node linked downstream to the second node; and assigning the third node a third path-based tag, the third path-based tag comprising a third node identifier and a second prefix, the second prefix identifying the first node and the second node.

In some embodiments, determining the root cause of the fault can include determining that a node identified in the fault domain comprises a prefix that identifies another node in the network that is not present in the fault domain.

### BRIEF DESCRIPTION OF THE DRAWINGS

FIG. 1 is a schematic diagram of an example computing network system in accordance with embodiments of the present disclosure.

FIG. 2 is a schematic diagram of an example computing network system illustrating nodes with associated path-based tags in accordance with embodiments of the present disclosure.

FIG. 3 is a schematic diagram of another example computing network system in accordance with embodiments of the present disclosure.

FIG. 4 is a schematic diagram of another example computing network system illustrating nodes with associated path-based tags in accordance with embodiments of the present disclosure.

FIG. 5 is a process flow diagram for associating a path-based tag with a set of nodes of a computing network in accordance with embodiments of the present disclosure.

FIG. 6 is a process flow diagram for isolating a fault in a computing network system using a path-based tag length in accordance with embodiments of the present disclosure.

FIG. 7 is a process flow diagram for isolating a fault of a computing network system using a path-based tag prefix in accordance with embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA.RTM., SCALA.RTM., SMALLTALK.RTM., EIFFEL.RTM., JADE.RTM., EMERALD.RTM., C++, C#, VB.NET, PYTHON.RTM. or the like, conventional procedural programming languages, such as the “C” programming language, VISUAL BASIC.RTM., FORTRAN.RTM. 2003, Perl, COBOL 2002, PHP, ABAP.RTM., dynamic programming languages such as PYTHON.RTM., RUBY.RTM. and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In computer networks, a number of issues arise, including traffic overload on parts of the network, optimum placement of network resources, security, isolation of network faults, and the like. These issues become more complex and difficult as networks become larger and more complex. For example, if a network device is not sending messages, it may be difficult to determine whether the fault is in the network device itself, the data communication link or an intermediate network device between the sending and receiving network devices.

Fault isolation includes monitoring a computer network system, identifying when a fault has occurred, and pinpointing the type of fault and its location. Fault isolation can be pro-active, which means that when the fault isolation mechanism determines that a device is non-responsive or non-functional, the fault isolation mechanism can go evaluate each neighboring node status and expand the fault domain recursively. This disclosure describes a fault isolation mechanism that can determine whether to consider a set of nodes as symptomatic based on intelligence without evaluating every neighboring node for fault.

In the systems, methods, network elements, and computer program products described herein, the fault isolation mechanism need not go to all of the downstream devices. Rather, the present disclosure describes path-based tagging to determine a fault domain (including root causes and symptoms). Advantages of the systems and techniques described herein are readily apparent to those of skill in the art. Among the advantages includes increased efficiency by forgoing evaluating all the network elements.

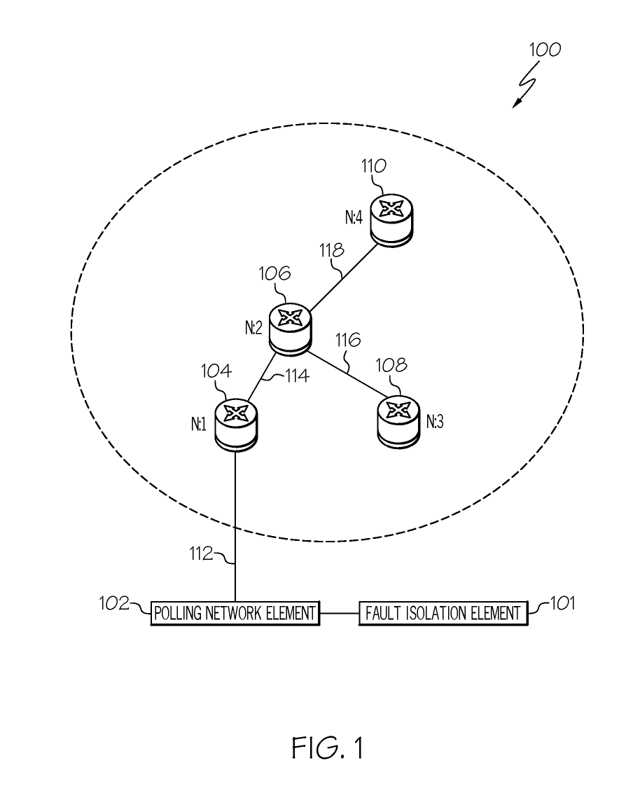

FIG. 1 is a schematic diagram of an example computing network system 100 in accordance with embodiments of the present disclosure. The computing network system can include a plurality of network elements, or nodes (e.g., nodes N:1 104, N:2 106, N:3 108, and N:4 110). A first node N:1 104 can be connected to a downstream node N:2 106 by a link 114. The node N:2 106 can be connected to downstream node N:3 108 by a link 116 and can be connected to a downstream node N:4 110 by a link 118. The nodes can be hardware devices, or can be virtual nodes that are instantiated on one or more hardware servers. The links can be hardwire links, wireless links, or virtual links. By way of example, the polling network element 102 is coupled to the node N:1 104 by a link 112; node N:1 104 is coupled to node N:2 106 by a link 114; node N:2 106 is coupled to node N:3 108 by a link 116; and node N:2 106 is coupled to node N:4 110 by a link 118.

The computing network system 100 can include a fault isolation element (or module) 101. The fault isolation element 101 can be part of a fault detection, isolation, and recovery (FDIR) system. The fault isolation element 101 can be implemented in hardware, software, or a combination of hardware and software. The fault isolation element 101 can include or be coupled to a polling network element 102 (often referred to as a fault poller). Polling network element 102 can include hardware, software, or a combination of hardware and software to manage and monitor the network elements of computing network system 100. The polling network element 102 polls the network to obtain node status information for one or more nodes in the computing network system 100. In some cases, the network devices send status information to the network management system automatically without polling. In either case, the information received from the network is processed so that the operational status, faults and other information pertaining to the network are presented to the user in a systematized and organized manner.

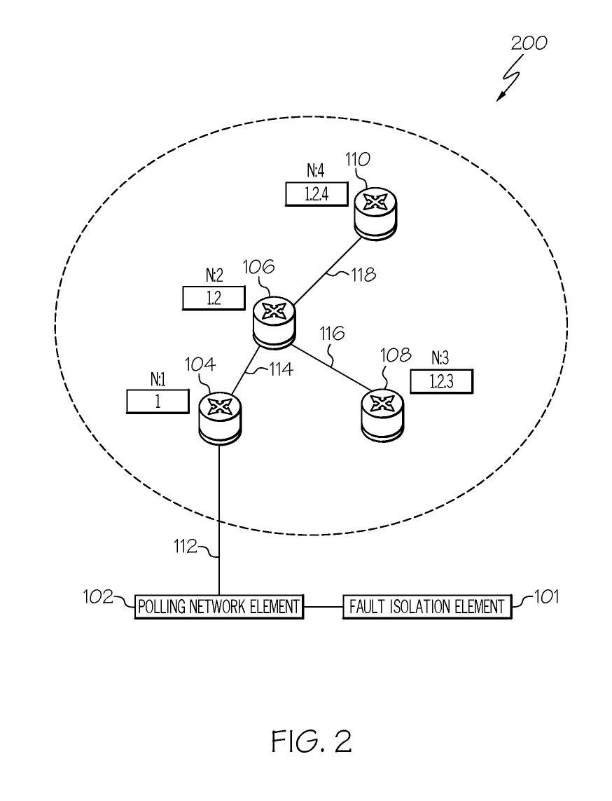

One or more network nodes N:1 104, N:2 106, N:3 108, or N:4 110 can undergo a fault, rendering the node nonresponsive to polls made by the polling network element 102. FIG. 2 illustrates how path-based tags can be used to create a fault domain without polling every network element in the computing network system 100. FIG. 2 is a schematic diagram of an example computing network system illustrating nodes with associated path-based tags in accordance with embodiments of the present disclosure. During the connection setup of the nodes in the computing network system 100, a tag can be assigned to each node based on the nodes position in the network relative to the polling network element 102 and the nodes connected neighbors.

For example, node N:1 104 can be assigned a tag of “1” because it is directly connected to the polling network element 102 (i.e., there are no intermediate nodes between N:1 104 and the polling network element 102). The node N:2 106 can be assigned at tag of “1.2” because node N:2 is a downstream node relative to node N:1 104. The node N:3 108 can be assigned a tag of “1.2.3” because node N:3 is connected downstream of the polling network element 102 and connected to node N:2 104. Similarly, node N:4 110 can be assigned a tag of “1.2.4” because node N:4 is connected downstream of the polling network element 102 and connected to node N:2 104. Table 1 below illustrates the node list and associated path-based tags:

TABLE 1
Node List and Associated Tags

| Node | Path Tag |
|---|---|
| 1 | 1 |
| 2 | 1.2 |
| 3 | 1.2.3 |
| 4 | 1.2.4 |

If a node undergoes a fault and is non-responsive to the polling network element 102, the polling network element 102 polls the nodes to build a fault domain to isolate the one or more nodes that are in a fault condition. By way of example, assume that node N:2 106 is fault. The polling network element 106 can begin polling upstream nodes, N:1 104, which responds indicating that N:1 104 is not faulty. The polling network element 102 can then poll N:2 106. If the polling network element 102 determines that the node N:2 106 is nonresponsive, then the polling network element 102 can forgo polling other downstream nodes connected to N:2 106. The polling network element 102 can build the fault domain using the nodes N:2 106 and all downstream nodes (e.g., nodes N:3 108 and N:4 110). The fault domain is illustrated in Table 2:

TABLE 2
First Example Fault Domain

| Node | Path Tag |
|---|---|
| 2 | 1.2 |
| 3 | 1.2.3 |
| 4 | 1.2.4 |

The polling network element 102 can determine that the root cause of the fault is the node within the fault domain having a tag with the smallest tag string. For example, from the fault domain shown in Table 2, the root cause of the fault is determined to be N:2 106 without having to poll N:3 108 and N:4 110. Nodes N:3 108 and N:4 110 can be considered as symptomatic, as opposed to a root cause of the fault.

The tags shown in Table 2can be structured as having prefixes. For example, node N:2 106 can have a tag of 1.2, which has a prefix of “1” and a name tag of “2.” Likewise, the node N:3 108 can have a prefix of 1.2.3, which as a prefix of “1.2” and a name tag of “3.” Other naming conventions can be used, but for ease of illustration, numbers are used herein.

In embodiments, the polling network element 102 can use the prefix to determine a node that is a root cause of a fault. For example, a first node that is within the fault domain whose prefix is in a normal condition (i.e., the prefix identifies a node not present in the fault domain) can be considered the root cause of the fault. In the example above, node N:2 106 has a prefix of 1, which identifies N:1 104. Node N:1 104 is not present in the fault domain, so the polling network element 102 can determine that node N:2 106 is the root cause of the fault, while all other nodes are symptomatic. The other nodes have prefixes of 1.2, which identifies node N:2 106. Since node N:2 106 is in the fault domain, these other nodes (N:3 108 and N:4 110) are considered symptomatic.

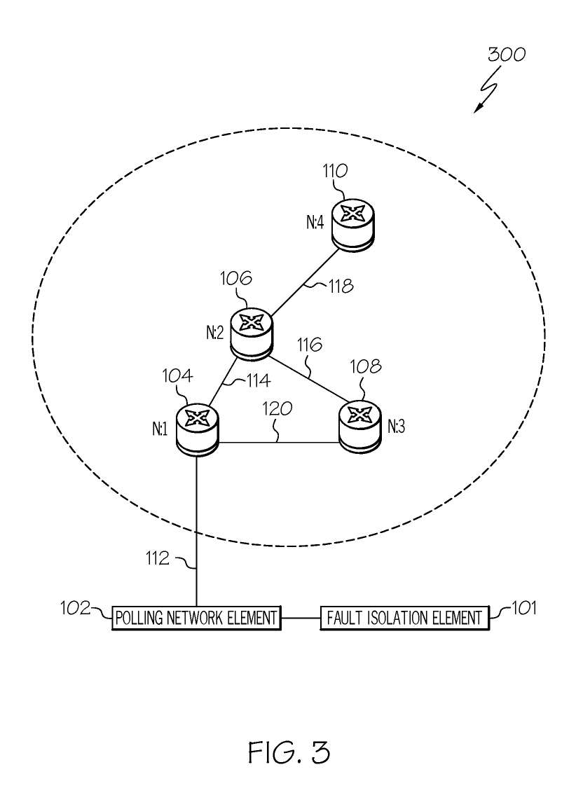

FIG. 3 is a schematic diagram of another example computing network system 300 in accordance with embodiments of the present disclosure. Computing network system 300 is similar to computing network system 100 described above. In computing network system 300, however, node N:1 104 is linked to node N:3 108 by a link 120. The addition of a link 120 between node N:1 104 and node N:3 108 expands the path-based tags.

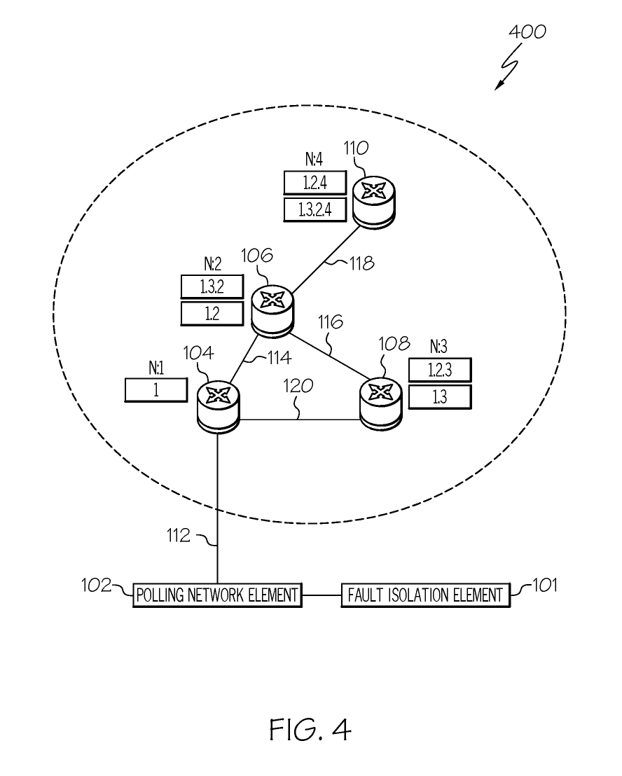

FIG. 4 is a schematic diagram of another example computing network system illustrating nodes with associated path-based tags in accordance with embodiments of the present disclosure. For example, node N:1 104 can be assigned a tag of “1” because it is directly connected to the polling network element 102 (i.e., there are no intermediate nodes between N:1 104 and the polling network element 102). The node N:2 106 can be assigned at tag of “1.2” because node N:2 is a downstream node relative to node N:1 104. The node N:2 106 is also assigned the tag of “1.3.2” because node N:2 is connected to node N:1 104 by intermediate node N:3 108.

The node N:3 108 can be assigned a tag of “1.2.3” because node N:3 is connected downstream of the polling network element 102 and connected to node N:2 104. Node N:3 is also assigned the tag of “1.3” because node N:3 108 is directly connected to node N:1 104 by link 120.

Node N:4 110 can be assigned a tag of “1.2.4” because node N:4 is connected downstream of the polling network element 102 and connected to node N:2 104. Node N:4 110 is also assigned the tag of “1.3.2.4.” Table 3 below illustrates the node list and associated path-based tags:

TABLE 3
Node List and Associated Tags

| Node | Path Tag |
|---|---|
| 1 | 1 |
| 2 | 1.2 |
| | 1.3.2 |
| 3 | 1.2.3 |
| | 1.3 |
| 4 | 1.2.4 |
| | 1.3.2.4 |

Assuming again that node N:2 106 is faulty, then the polling network element 102 will not receive a polling response from nodes N:2 106 and N:4 110. The fault domain, therefore, will include nodes N:2 and N:4, as shown in Table 4.

TABLE 4
Second Example Fault Domain

| Node | Path Tag |
|---|---|
| 2 | 1.2 |
| | 1.3.2 |
| 4 | 1.2.4 |
| | 1.3.2.4 |

Between nodes N:2 106 and N:4 110, N:2 106 has the smallest tag (i.e., 1.2). The polling network element 102 can determine that node N:2 106 is the root cause of the fault based on the fact that node N:2 106 has the smallest tag. In embodiments, the polling network element 102 can use the prefix of the tags to determine the root cause. In this example, node N:2 has a tag with a prefix of 1 and a tag with a prefix of 1.3. Both tags point to nodes that are not in the fault domain, and are therefore considered to be in a normal condition. Nodes that appear in the fault domain with prefixes that point to nodes in the normal condition can be considered root causes of the fault.

Node N:4 110 has a tag with a prefix of 1.2 and a tag with a prefix of 1.3.2, both of which point to node N:2 106, which is present in the fault domain. Therefore, the polling network element 102 can determine that the node N:4 is symptomatic of the fault, and not the root cause of the fault.

In another example, nodes N:2 106 and N:3 108 can be faulty, rendering N:2 106, N:3 108, and N:4 110 nonresponsive and part of the fault domain. Table 5 illustrates the fault domain for this third example:

TABLE 5
Third Example Fault Domain

| Node | Path Tag |
|---|---|
| 2 | 1.2 |
| | 1.3.2 |
| 3 | 1.2.3 |
| | 1.3 |
| 4 | 1.2.4 |
| | 1.3.2.4 |

The shortest tags within the fault domain are tag “1.2” pointing to node N:2 106 and tag “1.3” pointing to node N:3 108. The polling network element 102 can determine that nodes N:2 106 and N:3 108 are root causes of the fault based on the length of the tags; while node N:4 110 is symptomatic.

In embodiments, the polling network element 102 can use the prefix of the tags to determine the root cause. In this example, node N:2 106 has a tag with a prefix of 1 and a tag with a prefix of 1.3. Prefix tag 1 points to a node N:1 104 that is not in the fault domain and is considered to be in a normal condition. Therefore, node N:2 106 can be considered a root cause of the fault, even though node N:2 106 also has a prefix of 1.3, which is in the fault domain. Likewise, node N:3 108 has a tag with a prefix of 1 and a tag with a prefix of 1.2. Prefix tag 1 points to a node N:1 104 that is not in the fault domain and is considered to be in a normal condition. Therefore, node N:3 108 can be considered a root cause of the fault, even though node N:3 108 also has a prefix of 1.2, which is in the fault domain. Nodes that appear in the fault domain with prefixes that point to nodes in the normal condition can be considered root causes of the fault.

Node N:4 110 has a tag with a prefix of 1.2 and a tag with a prefix of 1.3.2, both of which point to node N:2 106, which is present in the fault domain. Therefore, the polling network element 102 can determine that the node N:4 is symptomatic of the fault, and not the root cause of the fault.

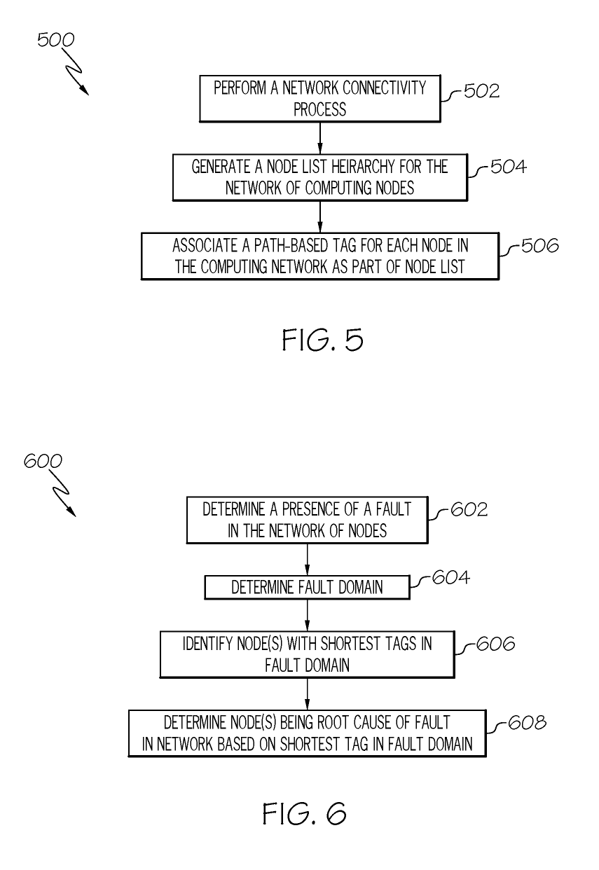

FIG. 5 is a process flow diagram 500 for associating a path-based tag with a set of nodes of a computing network in accordance with embodiments of the present disclosure. A connectivity process (e.g., a network initialization or periodic update of a connectivity list) can be performed (502). A node list identifying a hierarchy of nodes within the network can be built (504). A path-based tag can be associated with each node in the node list (506). The path-based tags for each node are unique, and each node can have one or more tags.

FIG. 6 is a process flow diagram 600 for identifying a fault domain of a computing network system in accordance with embodiments of the present disclosure. A polling network element can determine that one or more nodes in a network of nodes are faulty or nonresponsive (602). The polling network element can build a fault domain using nodes that are nonresponsive (604). The fault domain can include nodes and associated path-based tags. The polling network element can determine nodes having the shortest path-based tags (606). The polling network element can determine one or more root causes of the fault based on the nodes having the shortest path-based tags (608).

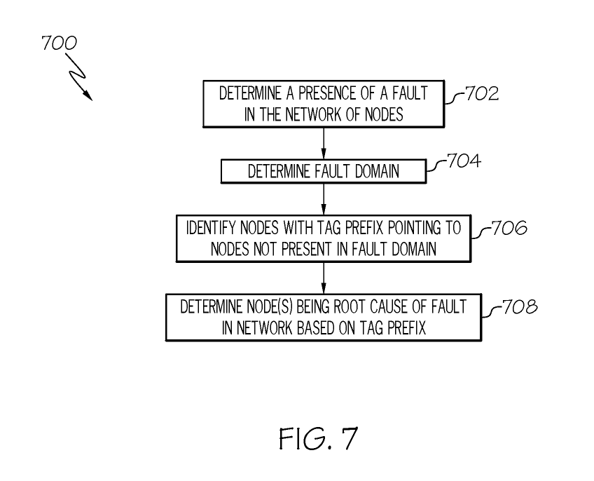

FIG. 7 is a process flow diagram 700 for identifying a fault domain of a computing network system in accordance with embodiments of the present disclosure. A polling network element can determine that one or more nodes in a network of nodes are faulty or nonresponsive (702). The polling network element can build a fault domain using nodes that are nonresponsive (704). The fault domain can include nodes and associated path-based tags. The polling network element can determine nodes that have tags that point to upstream nodes that are in a normal condition or not part of the fault domain (706). The polling network element can determine one or more root causes of the fault based on the prefixes of the tags in the fault domain (708).

Advantages of the present disclosure are readily apparent to those of skill in the art. Among the advantages includes an increase in the speed of isolating root causes of faulty nodes within the network.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the disclosure. Other embodiments will be apparent to those of ordinary skill in the art from a consideration of the specification or practice of the disclosure disclosed herein. It will also be understood by those of ordinary skill in the art that the scope of the disclosure is not limited to use in a server diagnostic context, but rather that embodiments of the disclosure may be used in any transaction having a need to monitor information of any type. The specification and the described examples are considered as exemplary only, with the true scope and spirit of the disclosure indicated by the following claims.

As indicated above, the network entities that make up the network that is being managed by the network management system are represented by software models in the virtual network machine. The models represent network devices such as printed circuit boards, printed circuit board racks, bridges, routers, hubs, cables and the like. The models also represent locations or topologies. Location models represent the parts of a network geographically associated with a building, country, floor, panel, rack, region, room, section, sector, site or the world. Topological models represent the network devices that are topologically associated with a local area network or subnetwork. Models can also represent components of network devices such as individual printed circuit boards, ports and the like. In addition, models can represent software applications such as data relay, network monitor, terminal server and end point operations. In general, models can represent any network entity that is of interest in connection with managing or monitoring the network.

The virtual network machine includes a collection of models which represent the various network entities. The models themselves are collections of C++ objects. The virtual network machine also includes model relations which define the interrelationships between the various models. Several types of relations can be specified. A “connects to” relation is used to specify an interconnection between network devices. For example, the interconnection between two workstations is specified by a “connects to” relation. A “contains” relation is used to specify a network entity that is contained within another network entity. Thus for example, a workstation model may be contained in a room, building or local network model. An “executes” relation is used to specify the relation between a software application and the network device on which it runs. An “is part of” relation specifies the relation between a network device and its components. For example, a port model may be part of a board model or a card rack model.

What is claimed is:

1. A computer-implemented method for fault isolation in a network of nodes, the method comprising:
determining, by a polling network element, a presence of a fault among one or more nodes in a network of nodes;
identifying, by the polling network element, a fault domain comprising a list of nonresponsive nodes in the network, the fault domain listing each nonresponsive node and an associated path-based tag for each nonresponsive node; and
identifying a root cause of a fault in the network based on a shortest path-based tag in the fault domain.

2. The computer-implemented method of claim 1, further comprising:
determining, by the polling network element, that one or more nodes in the fault domain comprise path-based tags that are longer than the shortest path-based tag; and
determining, by the polling network element, that the one or more nodes that comprise path-based tags that are longer than the shortest path-based tag are symptomatic of the fault.

3. The computer-implemented method of claim 1, further comprising:
during a connectivity process, determining a first node linked downstream to the polling network element;
assigning the first node a first path-based tag, the first path-based tag comprising a first length;
determining a second node linked downstream to the first node;
assigning the second node a second path-based tag, the second path-based tag comprising a second length longer than the first length;
determining a third node linked downstream to the second node; and
assigning the third node a third path-based tag, the third path-based tag comprising a third length longer than the first length and the second length.

4. The computer-implemented method of claim 3, wherein:
the first path-based tag comprises an identifier of the first node;
the second path-based tag comprises the identifier of the first node as a prefix and an identifier of the second node; and
the third path-based tag comprises the identifier of the first node and the identifier of the second node as a prefix and an identifier of the third node.

5. The computer-implemented method of claim 1, further comprising communicating by the polling network element to a fault isolation module the root cause of the fault.

6. A non-transitory computer-readable medium having program instructions stored therein, wherein the program instructions are executable by a computer system to perform operations comprising:
determining, by a polling network element, a presence of a fault among one or more nodes in a network of nodes;
identifying, by the polling network element, a fault domain comprising a list of nonresponsive nodes in the network, the fault domain listing each nonresponsive node and an associated path-based tag for each nonresponsive node;
identifying a root cause of a fault in the network based on a shortest path-based tag in the fault domain.

7. The non-transitory computer-readable medium of claim 6, the operations further comprising:
determining, by the polling network element, that one or more nodes in the fault domain comprise path-based tags that are longer than the shortest path-based tag; and
determining, by the polling network element, that the one or more nodes that comprise path-based tags that are longer than the shortest path-based tag are symptomatic of the fault.

8. The non-transitory computer-readable medium of claim 6, the operations further comprising:
during a connectivity process, determining a first node linked downstream to the polling network element;
assigning the first node a first path-based tag, the first path-based tag comprising a first length;
determining a second node linked downstream to the first node;
assigning the second node a second path-based tag, the second path-based tag comprising a second length longer than the first length;
determining a third node linked downstream to the second node; and
assigning the third node a third path-based tag, the third path-based tag comprising a third length longer than the first length and the second length.

9. The non-transitory computer-readable medium of claim 8, the operations further comprising:
the first path-based tag comprises an identifier of the first node;
the second path-based tag comprises the identifier of the first node as a prefix and an identifier of the second node; and
the third path-based tag comprises the identifier of the first node and the identifier of the second node as a prefix and an identifier of the third node.

10. The non-transitory computer-readable medium of claim 6, the operations further comprising:
communicating by the polling network element to a fault isolation module the root cause of the fault.

11. A system comprising:
a processor;
a memory;
a poller network element implemented at least partially in hardware, the poller network element to:
determine, by the poller network element, a presence of a fault among one or more nodes in a network of nodes;
identify, by the poller network element, a fault domain comprising a list of nonresponsive nodes in the network, the fault domain listing each nonresponsive node and an associated path-based tag for each nonresponsive node;
identify a root cause of a fault in the network based on a shortest path-based tag in the fault domain.

12. The system of claim 11, wherein the poller network element is to manage the one or more nodes of the network of nodes.

13. The system of claim 11, further comprising a fault isolation module to perform fault detection, isolation, and recovery (FDIR), wherein the poller network element is associated with the fault isolation module.

14. The system of claim 11, wherein identifying a fault domain comprises:
determining, by the poller network element, a list of unreachable nodes from the one or more nodes of the network of nodes, wherein the unreachable nodes are coupled for communication with the poller network element.

15. The system of claim 11, the poller network element to:
determine, by the poller network element, that one or more nodes in the fault domain comprise path-based tags that are longer than the shortest path-based tag; and
determine, by the poller network element, that the one or more nodes that comprise path-based tags that are longer than the shortest path-based tag are symptomatic of the fault.

16. The system of claim 11, wherein identifying a root cause of a fault in the network based on a shortest path-based tag in the fault domain comprises:
identifying, from the fault domain, a first path-based tag length; and
determining, by comparing the first path-based tag length with one or more other path-based tag lengths in the fault domain, that the first path-based tag length is a shortest path-based tag length.

17. The system of claim 11, the poller network element to determine a topology of the one or more nodes prior to identifying the fault domain.

18. The system of claim 11, the poller network element to:
during a connectivity process, determine a first node linked downstream to the poller network element;
assign the first node a first path-based tag, the first path-based tag comprising a first length;
determine a second node linked downstream to the first node;
assign the second node a second path-based tag, the second path-based tag comprising a second length longer than the first length;
determine a third node linked downstream to the second node; and
assign the third node a third path-based tag, the third path-based tag comprising a third length longer than the first length and the second length.

19. The system of claim 18, wherein:
the first path-based tag comprises an identifier of the first node;
the second path-based tag comprises the identifier of the first node as a prefix and an identifier of the second node; and
the third path-based tag comprises the identifier of the first node and the identifier of the second node as a prefix and an identifier of the third node.

20. The system of claim 11, the poller network element to communicate by the poller network element to the fault isolation module the root cause of the fault.
